(19) United States
(12) Patent Application Publication
(10) Pub. No.: US 2013/0304566 A1
(43) Pub. Date: Nov. 14, 2013

(54) APPARATUS AND METHOD FOR PROVIDING ADVERTISING RANKING INFORMATION

(71) Applicant: Samsung Electronics Co., Ltd., Gyeonggi-do (KR)

(72) Inventors: Jin-Wan Choi, Gyeonggi-do (KR); Won-Suk Yang, Seoul (KR); Hyun-Jung Lee, Seoul (KR)

(73) Assignee: Samsung Electronics Co., Ltd., Gyeonggi-do (KR)

(21) Appl. No.: 13/892,988

(22) Filed: May 13, 2013

(30) Foreign Application Priority Data
May 11, 2012 (KR) 10-2012-0050276

(51) Int. Cl. G06Q 30/02

(52) U.S. Cl. CPC G06Q 30/0242
USPC 705/14.41

(57) ABSTRACT

An apparatus and method provide advertising (Ad) ranking information. An Ad information collector collects Ad property information included in a plurality of advertisements. A feedback information collector collects feedback information that is determined as a function of Ad impressions. A table generator generates an Ad information collection table as a function of the Ad property information and the feedback information. A ranking calculator generates Ad ranking information for the plurality of advertisements using the generated Ad information collection table. Upon receiving an Ad request from an Ad exposure device, a processor requests the plurality of advertisements from a plurality of Ad networks, receives the requested plurality of advertisements from the plurality of Ad networks, receives the feedback information from the Ad exposure device, and transmits the generated Ad ranking information to the Ad exposure device along with the received plurality of advertisements.

### PRIORITY

This application claims priority under 35 U.S.C. §119(a) to Korean Patent Application Serial No. 10-2012-0050276 filed in the Korean Intellectual Property Office on May 11, 2012, the entire disclosure of which is incorporated herein by reference.

### BACKGROUND OF THE INVENTION

1. Field of the Invention

The present invention relates generally to an apparatus and method for providing advertising (Ad) ranking information, and more particularly, to an apparatus and method for providing Ad ranking information as a function of Ad information for a plurality of advertisements.

2. Description of the Related Art

Mobile devices that users can use while on the move, such as smart phones, are products that many people such as, for example, the mass media (e.g., Televisions (TVs) and newspapers), often use. A variety of efforts have been made to generate revenues by providing advertisements over mobile devices.

There are a lot of existing mobile advertising methods for providing advertisements to mobile devices. For example, mileage coupons, discount coupons and the like may be created as text or image data and transmitted to the mobile devices of users unilaterally. In addition, advertisements may be posted, in the form of content, on wireless Internet pages that experience a significant amount of traffic from mobile devices so that users may access the wireless Internet pages on their mobile devices and recognize the Ad content. In addition, users may be induced to recognize the pre-designed mobile advertising sites so that they may visit the mobile advertising sites on their mobile devices.

Presently, there exists a mobile advertising method that uses an Ad Software Development Kit (SDK). In the mobile advertising method using the Ad SDK, when developing applications (Apps) or websites, App developers or web developers create and provide, using the Ad SDK, Apps or webs that include Ad features (or Ad clients) by which users may receive advertisements corresponding to the categories, keywords and/or metadata associated with the Apps or websites. According to the mobile advertising method using the Ad SDK, a mobile device may receive advertisements corresponding to the categories, keywords and/or metadata associated with the App as an Ad client. The Ad client included in the App is activated while the mobile device downloads and executes the App. Otherwise, a mobile device may receive advertisements corresponding to the categories, keywords and/or metadata associated with the website, when an Ad client included in the website is activated while the mobile device browses the web.

Ad agents may provide these advertisements in a round robin or mediation mode.

In the round robin mode, an Ad exposurer (or Ad exposure device) that exposes advertisements, such as a device, requests advertisements from an Ad agent such as an Ad-serving system. The Ad agent sets and provides advertisements received from a plurality of Ad providers to be exposed in order depending on a fixed ratio.

In the mediation mode, if the Ad exposurer requests advertisements from the Ad agent, the Ad agent sets and provides advertisements received from a plurality of Ad providers so that advertisements from a specific Ad provider may be exposed more frequently, based on a predetermined weight. In this mode, the Ad agent may earn more revenue through competition among advertisers.

As described above, conventionally, the Ad agent sets and provides advertisements to be exposed in order based on a fixed ratio, or sets and provides advertisements so that advertisements from a specific Ad provider may be exposed more frequently.

Since a selected plurality of advertisements are set and provided based on the predetermined ratio, it is difficult to reflect the information collected from the Ad providers, Ad exposurers and Ad agents, during the provision of advertisements.

In some cases, the Ad agent may not be able to provide advertisements to the Ad exposurer because there is no advertisement desired by the Ad exposurer among the advertisements selected by the predetermined ratio.

In addition, it is difficult for advertisers to mainly provide high-revenue advertisements since only predetermined advertisements are provided to Ad exposurers.

### SUMMARY OF THE INVENTION

The present invention has been made to address at least the above-mentioned problems and/or disadvantages and to provide at least the advantages described below. Accordingly, an aspect of the present invention provides an apparatus and method for providing Ad ranking information determined by assigning rankings to a plurality of advertisements as a function of Ad information for the plurality of advertisements and feedback information that is collected as a function of Ad impressions (or Ad exposures).

In accordance with one aspect of the present invention, there is provided an apparatus for providing advertising (Ad) ranking information. The apparatus includes an Ad information collector for collecting Ad property information included in a plurality of advertisements; a feedback information collector for collecting feedback information that is determined as a function of Ad impressions; a table generator for generating an Ad information collection table as a function of the Ad property information and the feedback information; a ranking calculator for generating Ad ranking information for the plurality of advertisements using the generated Ad information collection table; and a processor for, upon receiving an Ad request from an Ad exposure device, requesting the plurality of advertisements from a plurality of Ad networks, receiving the requested plurality of advertisements from the plurality of Ad networks, receiving the feedback information from the Ad exposure device, and transmitting the generated Ad ranking information to the Ad exposure device along with the received plurality of advertisements.

In accordance with another aspect of the present invention, there is provided a method for providing advertising (Ad) ranking information in an Ad ranking information providing apparatus. The method includes requesting a plurality of advertisements from a plurality of Ad networks, upon receiving an Ad request from an Ad exposure device; receiving the plurality of advertisements from the plurality of Ad networks and collecting Ad property information included in the plurality of advertisements; receiving feedback information that is determined as a function of Ad impressions, from the Ad exposure device, and collecting the feedback information; generating an Ad information collection table as a function of the Ad property information and the feedback information; generating Ad ranking information for the plurality of advertisements using the generated Ad informant collection table; and transmitting the generated Ad ranking information to the Ad exposure device together with the plurality of advertisements.

### BRIEF DESCRIPTION OF THE DRAWINGS

The above and other aspects, features and advantages of embodiments of the present invention will be more apparent from the following description taken in conjunction with the accompanying drawings, in which:

FIG. 1 illustrates a configuration of an Ad-serving system according to an embodiment of the present invention;

FIG. 2 illustrates a structure of an Ad ranking server according to an embodiment of the present invention;

FIG. 3 is a flowchart illustrating a process of generating and providing Ad ranking information in an Ad ranking server according to an embodiment of the present invention;

FIG. 4 illustrates an Ad information table generated by collecting Ad information received from a plurality of Ad networks according to an embodiment of the present invention;

FIG. 5 illustrates a feedback information table generated by collecting feedback information received from a device according to an embodiment of the present invention; and

FIG. 6 illustrates an Ad information collection table generated as a function of collected Ad information and feedback information according to an embodiment of the present invention.

Throughout the drawings, the same drawing reference numerals will be understood to refer to the same elements, features and structures.

### DETAILED DESCRIPTION OF EMBODIMENTS OF THE PRESENT INVENTION

Embodiments of the present invention will now be described in detail with reference to the accompanying drawings. In the following description, specific details such as detailed configuration and components are merely provided to assist the overall understanding of embodiments of the present invention. Therefore, it should be apparent to those skilled in the art that various changes and modifications of the embodiments described herein can be made without departing from the scope and spirit of the invention. In addition, descriptions of well-known functions and constructions are omitted for clarity and conciseness.

According to the present invention, upon receiving an Ad request from an Ad exposure device, an Ad-serving system receives and collects advertisements and Ad information from a plurality of Ad networks (or Ad providers), receives and collects feedback information for the plurality of advertisements from the Ad exposure device, generates Ad ranking information determined by assigning rankings to the plurality of advertisements as a function of the collected Ad information and feedback information, and provides the generated Ad ranking information along with the request advertisements, thereby making it possible to maximize the revenues of the Ad exposurers (or Ad exposure devices) and the advertisers.

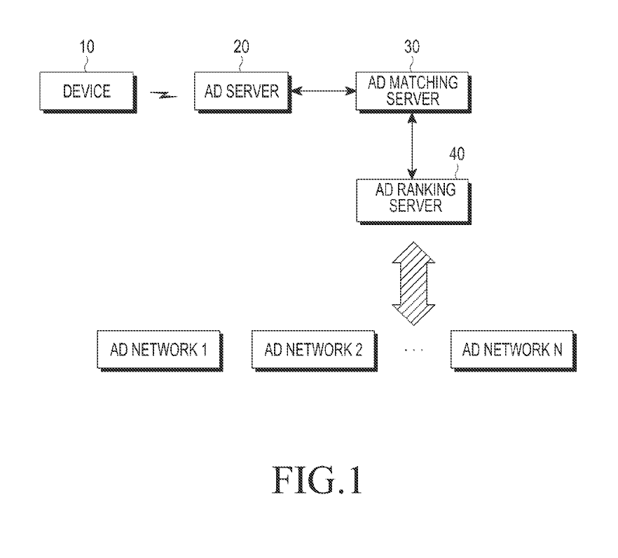

FIG. 1 illustrates a configuration of an Ad-serving system according to an embodiment of the present invention.

Referring to FIG. 1, the Ad-serving system includes an Ad server 20, an Ad matching server 30, and an Ad ranking server 40.

The Ad server 20 receives an Ad request signal from a device 10 (or Ad exposure device), and analyzes the Ad request signal. The Ad request signal may include device information which includes the device's unique ID, time information, local information, user information, and request information, which includes category and keyword information used for receiving advertisements and which the device 10 requires to receive advertisements. The Ad server 20 forwards the Ad request signal including request information to the Ad matching server 30. Upon receiving the requested advertisement from the Ad matching server 30, the Ad server 20 forwards the advertisement to the device 10. The device 10 may include any device that is capable of outputting advertisements such as, for example, a smart phone, a cellular phone, a game console, a TV, a display device, a car head unit, a notebook computer, a laptop computer, a tablet Personal Computer (PC), a Personal Media Player (PMP), a Personal Digital Assistant (PDA) and the like.

Upon receiving the Ad request signal, including the request information, from the Ad server 20, the Ad matching server 30 forwards the received Ad request signal to the Ad ranking server 40. Upon receiving Ad ranking information from the Ad ranking server 40 together with the requested advertisement, the Ad matching server 30 selects advertisements that it will provide to the device 10, as a function of the Ad ranking information, and delivers the selected advertisements to the Ad server 20.

Upon receiving the Ad request signal from the Ad matching server 30, the Ad ranking server 40 extracts the request information included in the Ad request signal, and delivers the Ad request signal for requesting one or more advertisements, corresponding to the extracted request information, to the plurality of Ad networks.

The Ad ranking server 40 receives the plurality of advertisements and Ad property information for the advertisements from the plurality of Ad networks in response to the Ad request signal, receives feedback information for the plurality of advertisements, which are determined as a function of the Ad impressions (or Ad exposures), from one or more devices 10, and collects the received information. The Ad property information includes a name of an Ad network providing advertisements, an Ad name, a category name, a Cost Per Millenium (CPM) which is incurred when each advertisement is exposed, a Cost Per Click (CPC) which is incurred when each advertisement is clicked, and the like. The feedback information includes a keyword, an Ad network name, a time, a revenue type, an impression count, a click count, revenue by impressions, and revenue by clicks, for one or more advertisements.

The Ad ranking server 40 generates an Ad information collection table using the collected Ad property information and feedback information, calculates estimated Ad revenues and credit ratings for the plurality of advertisements using the generated Ad information collection table, and generates Ad ranking information determined by assigning a ranking to each of the advertisements as a function of the calculated estimated Ad revenues and credit ratings.

The Ad ranking server 40 delivers the generated Ad ranking information to the Ad matching server 30 together with the plurality of advertisements.

The plurality of Ad networks deliver the Ad property information to the Ad ranking server 40 along with the requested advertisements which are provided in response to the Ad request from the Ad ranking server 40.

As such, according to the present invention, the Ad-serving system generates Ad ranking information for the plurality of advertisements, and provides high-revenue advertisements using the generated Ad ranking information, thereby making it possible to maximize the revenues of the Ad exposurers and the advertisers.

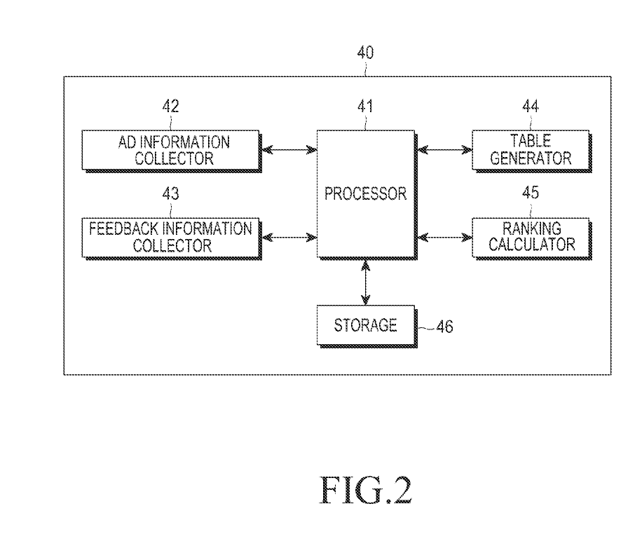

FIG. 2 illustrates a structure of the Ad ranking server according to an embodiment of the present invention.

In this embodiment, the Ad ranking server 40 includes a processor 41, an Ad information collector 42, a feedback information collector 43, a table generator 44, a ranking calculator 45, and a storage element 46.

The processor 41 controls the overall operation of the Ad ranking server 40.

In particular, the processor 41 receives the Ad request signal including the device information and request information, containing category and keyword information, from the device 10 through the Ad matching server 30.

The processor 41 extracts the request information from the received Ad request signal, and transmits a request signal for requesting advertisements corresponding to the extracted request information, to the plurality of Ad networks. In other words, the processor 41 transmits the request signal for requesting advertisements corresponding to the device information and the category and keyword information, to the plurality of Ad networks.

Upon receiving requested one or more advertisements from the plurality of Ad networks, the processor 41 controls the Ad information collector 42 to collect one or more advertisements and Ad property information included in the advertisements, and stores the collected Ad property information in the storage element 46. The processor 41 may generate an Ad property information table including the name of an Ad network providing advertisements, the Ad name, the category name, the CPC price, the CPM price and the like, for each of the advertisements, and may store the generated Ad property information table in the storage element 46. The CPC price refers to the Ad revenue which is generated when each advertisement is clicked, and the CPM price refers to the Ad revenue which is generated per 1000 impressions.

Upon receiving the feedback information for the plurality of advertisements from the one or more devices 10, the processor 41 controls the feedback information collector 43 to collect the feedback information, and stores the collected feedback information in the storage element 46. The processor 41 may generate a feedback information table including an Ad ID, a keyword, an Ad network name, a time, a revenue, a revenue type, the CPM, a Click Through Rate (CTR) and the like, for each advertisement, and may store the feedback information table in the storage element 46. The CTR refers to a ratio of the CPC to the total CPM.

The processor 41 controls the table generator 44 to generate an Ad information collection table including collected information for each advertisement with respect to each keyword or category, as a function of the collected Ad property information and the feedback information. This Ad information collection table includes the Ad name, the Ad network name, a request count, a response count, an average response time, the impression count, an average CPM, the click count, an average CPC and the like, for each keyword or category. The term “Ad network” refers to an Ad company providing advertisements. The keyword or category includes information used for an Ad search. the term “request count” refers to a number of requests for requesting advertisements from the Ad networks. the term “response count” refers to the number of responses that the Ad networks have made in response to the requests. The term “average response time” refers to an average time required by each advertisement to respond. The term “impression count” refers to the number of impressions for each advertisement. The term “average CPM” refers to the average cost which is incurred when each advertisement is exposed. The term “click count” refers to the number of clicks for each advertisement. The term “average CPC” refers to the average cost which is incurred when each advertisement is clicked.

The processor 41 controls the ranking calculator 45 to calculate estimated Ad revenues and credit ratings for the plurality of advertisements, which are used for Ad ranking, using the generated Ad information collection table. The estimated Ad revenue is a sum of estimated impression revenue and estimated click revenue. The term “estimated impression revenue” refers to the Ad revenue which is estimated when an advertisement, which is selected by a specific keyword and provided from a specific Ad network, is exposed. The term “estimated click revenue” refers to the Ad revenue which is estimated when an advertisement, which is selected by a specific keyword and provided from a specific Ad network, is clicked. In addition, the credit rating includes a ratio of the average response time to the total Ad revenue for a specific advertisement. The processor 41 may determine that the credit rating increases as the ratio increases.

The processor 41 generates the Ad ranking information determined by assigning a ranking to each of the advertisements for each keyword depending on the calculated estimated Ad revenues and credit ratings. For example, the processor 41 may assign the highest ranking to the advertisement having the highest estimated Ad revenue and highest credit rating among the advertisements corresponding to a specific keyword, and assign the lowest ranking to the advertisement having the lowest estimated Ad revenue and lowest credit rating.

The processor 41 transmits an Ad response signal including the generated Ad ranking information to the device 10 along with the plurality of advertisements through the Ad matching server 30.

The Ad information collector 42, under control of the processor 41, collects Ad property information included in one or more advertisements received from the plurality of Ad networks.

The feedback information collector 43, under control of the processor 41, collects the feedback information for the plurality of advertisements, which is received from the one or more devices 10.

The table generator 44, under control of the processor 41, generates the Ad information collection table including the collected information for each advertisement with respect to each keyword or each category, as a function of the collected Ad property information and the feedback information.

The ranking calculator 45, under control of the processor 41, calculates the estimated Ad revenues and the credit ratings for the plurality of advertisements, which are used for Ad ranking, using the generated Ad information collection table.

The storage element 46 stores the data needed the for the Ad ranking server 40. In particular, the storage element 46 stores the collected Ad property information, the feedback information, and the generated Ad information collection table. In addition, the storage element 46 stores a computation algorithm used to calculate the estimated Ad revenues and credit ratings.

As such, according to the present invention, the Ad-serving system generates Ad ranking information for the plurality of advertisements, and provides high-revenue advertisements using the generated Ad ranking information, thereby making it possible to maximize the revenues of the Ad exposurers and the advertisers.

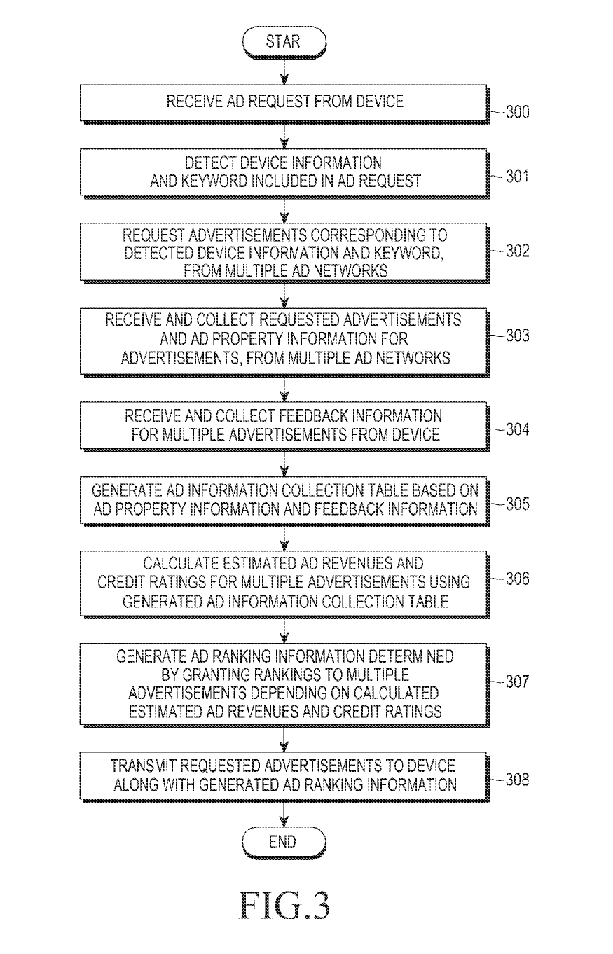

FIG. 3 is a flowchart illustrating a process of generating and providing the Ad ranking information in the Ad ranking server according to an embodiment of the present invention.

Referring to FIG. 3, the processor 41 receives the Ad request signal from the device 10 in step 300. The Ad request signal is received via the Ad server 20 and the Ad matching server 300, and includes the device information and the request information containing the category and keyword information.

In step 301, the processor 41 extracts the device information and keywords from the received Ad request signal. The Ad request signal may also include the category information.

In step 302, the processor 41 requests advertisements corresponding to the extracted device information and keywords, from the plurality of Ad networks. In other words, the processor 41 generates the request signal for requesting advertisements corresponding to the extracted request information, and transmits the request signal to the plurality of Ad networks.

In step 303, the processor 41 causes the Ad information collector 42 to receive and collect the requested one or more advertisements and Ad property information for the advertisements from the plurality of Ad networks. The Ad property information is included in the one or more advertisements.

In step 304, the processor 41 causes the feedback information collector 43 to receive and collect the feedback information for the plurality of advertisements from the device 10.

In step 305, the processor 41 causes the table generator 44 to generate the Ad information collection table as a function of the Ad property information and feedback information.

In step 306, the processor 41 causes the ranking calculator 45 to calculate the estimated Ad revenues and credit ratings for the plurality of advertisements, which are used for the Ad ranking, using the generated Ad information collection table.

In step 307, the processor 41 generates the Ad ranking information determined by assigning rankings to the plurality of advertisements depending on the calculated estimated Ad revenues and credit ratings.

In step 308, the processor 41 transmits the plurality of advertisements to the device 10 together with the generated Ad ranking information. In other words, the processor 41 transmits the plurality of advertisements to the device 10 through the Ad matching server 30 along with the Ad response signal including the generated Ad ranking information.

As such, according to the present invention, the Ad-serving system generates the Ad ranking information for the plurality of advertisements, and provides high-revenue advertisements using the generated Ad ranking information, thereby making it possible to maximize the revenues of the Ad exposurers and the advertisers.

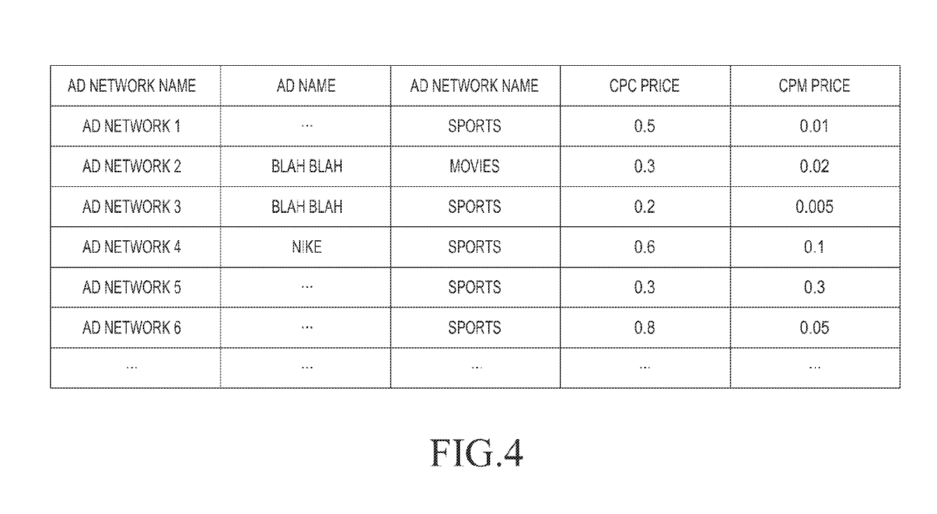

FIG. 4 illustrates an Ad information table generated by collecting Ad information received from the plurality of Ad networks according to an embodiment of the present invention.

Referring to FIG. 4, the processor 41 causes the table generator 44 to generate an Ad property information table including the Ad property information that is collected by the Ad information collector 42. As illustrated in FIG. 4, the generated Ad property information table may include a name of an Ad network providing each advertisement, an Ad name, a category, a CPC price, a CPM price and the like, for each advertisement.

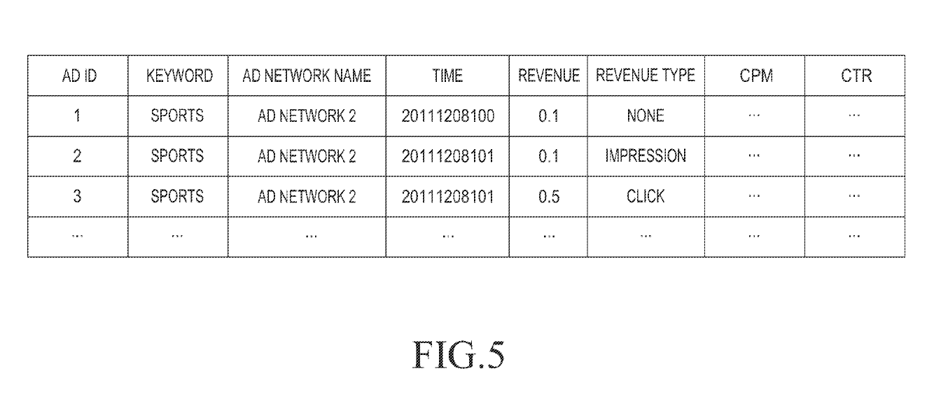

FIG. 5 illustrates a feedback information table generated by collecting feedback information received from a device according to an embodiment of the present invention.

Referring to FIG. 5, the processor 41 causes the table generator 44 to generate a feedback information table including the feedback information that is collected by the feedback information collector 43. The generated feedback information table may include an Ad ID, a keyword, an Ad network name, a time, revenue, a revenue type, CPM, CTR and the like, for each advertisement.

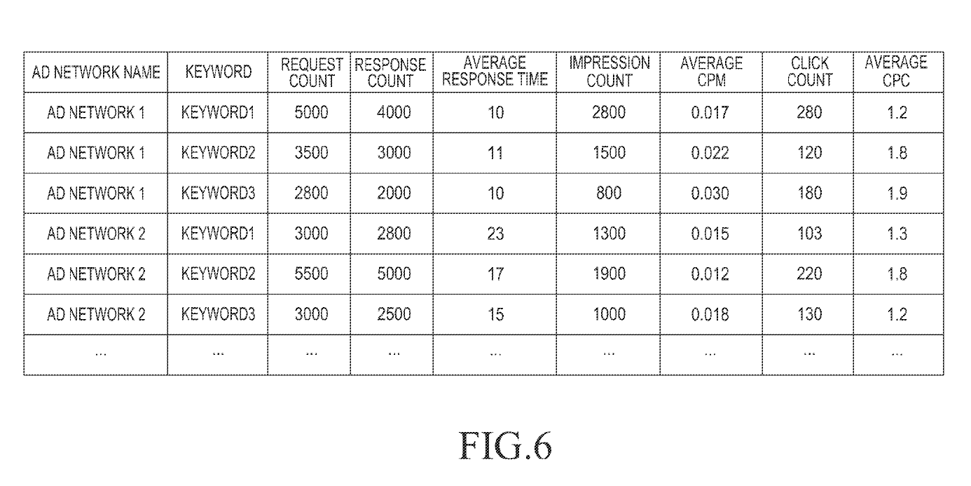

FIG. 6 illustrates an Ad information collection table generated as a function of collected Ad information and feedback information according to an embodiment of the present invention.

Referring to FIG. 6, the processor 41 causes the table generator 44 to generate an Ad information collection table including collected information for each advertisement with respect to each keyword or each category, as a function of the generated Ad property information table and feedback information table. As illustrated in FIG. 6, the Ad information collection table may include an Ad name, an Ad network name, a request count, a response count, an average response time, an impression count, an average CPM, a click count, an average CPC and the like, for each keyword or category.

In an embodiment of the present invention, the processor 41 may control the ranking calculator 45 to calculate estimated Ad revenues and credit ratings using the generated Ad information collection table. Specifically, the ranking calculator 45 may generate Ad ranking information using the following computational method.

The estimated Ad revenue refers to a sum of estimated impression revenue and estimated click revenue. The estimated impression revenue may be a value determined by multiplying an impression probability by the average CPM, and the impression probability may be calculated by dividing the response count by the impression count.

Estimated Impression Revenue=(Impression Probability)*(Average CPM)

Impression Probability=(Response Count)/(Impression Count)

The estimated click revenue may be a value determined by multiplying a click probability by the average CPC, and the click probability may be calculated by dividing the click count by the impression count.

Estimated Click Revenue=(Click Probability)*(Average CPC)

Click Probability=(Click Count)/(Impression Count)

The credit rating refers to a ratio of an average response time to the current total Ad revenue for each advertisement. The total Ad revenue refers to a sum of a) a product of the impression count and the average CPM and b) a product of the click count and the average CPC. The credit rating may be calculated by dividing the average response time by the total Ad revenue.

The calculated credit rating may be determined as the highest credit rating, if it has the highest value. A determination of whether a credit rating is high or low is made based on whether the credit rating corresponds to any one of a plurality of credit ratings within a threshold range. For example, one or more credit ratings may be characterized as the first-highest credit rating, if they fall within a range of 80˜100; the second-highest credit rating, if they fall within a range of 60˜79; the third-highest credit rating, if they fall within a range of 40˜59; the fourth-highest credit rating, if they fall within a range of 20˜39; and the fifth-highest credit rating, if they fall within a range of 0˜19. The calculated credit rating may be characterized as the highest credit rating if it corresponds to the first-highest credit rating or as the lowest credit rating if it corresponds to the fifth-highest credit rating. The ranges may be arbitrarily set, and may be changed by the user.

The ranking calculator 45 may assign rankings to the plurality of advertisements as a function of the estimated Ad revenues and credit ratings calculated by the computation algorithm. For example, the ranking calculator 45 assigns the highest ranking to the advertisement having the estimated highest Ad revenue and highest credit rating, and assigns the lowest ranking to the advertisement having the estimated lowest Ad revenue and lowest credit rating.

Thereafter, the processor 41 transmits the Ad ranking information for the plurality of advertisements, to which rankings are assigned, to the Ad matching server 30. The Ad ranking information includes ranking information for each of the advertisements.

Upon receiving the Ad ranking information, the Ad matching server 30 may provide a predetermined number of advertisements to the device 10 in order of the highest ranking as a function of the Ad ranking information. The Ad matching server 30 may provide the requested advertisements depending on various criteria as a function of the Ad ranking information.

According to the present invention, the Ad-serving system generates and provides Ad ranking information as a function of the Ad information for the plurality of advertisements and the feedback information collected depending on the Ad impressions, to provide high-revenue advertisements, thereby making it possible to maximize the revenues of the Ad exposurers and the advertisers.

Embodiments of the present invention may be implemented in the form of hardware, software or a combination of hardware and software. The software may be stored in volatile or nonvolatile storage devices (such as, for example, Read Only Memory (ROM) regardless of whether it is erasable or re-writable), memories (such as, for example, Random Access Memory (RAM), and memory chips, devices or Integrated Circuits (ICs)), or optically or magnetically recordable machine-readable (for example, computer-readable) storage media (such as, for example, Compact Disks (CDs), Digital Versatile Disks (DVDs), magnetic disks, or magnetic tapes). The storage element which is included in the Ad ranking server may be an example of a non-transitory machine-readable storage media suitable to store a program or programs including instructions for implementing exemplary embodiments of the present invention. Therefore, the present invention includes a program including codes for implementing the apparatus and method defined in any claims of this specification, and non-transitory machine-readable storage media storing the program. This program may be electronically transferred through any media such as communication signals which are delivered by wired/wireless connections, and the present invention may properly include any equivalent thereof.

In addition, the Ad ranking server may receive and store the program from a program server that is connected thereto by wire or wirelessly. The program server may include a memory for storing a program including instructions for implementing the method for providing Ad ranking information by the Ad ranking server, and storing the information required for the method for providing Ad ranking information; a communication unit for performing wired/wireless communication with the Ad ranking server; and a controller for transmitting the program to the Ad ranking server automatically or upon request of the Ad ranking server.

While the invention has been shown and described with reference to certain embodiments thereof, it will be understood by those skilled in the art that various changes in form and details may be made therein without departing from the spirit and scope of the invention as defined by the appended claims and their equivalents.

What is claimed is:

1. An apparatus for providing advertising (Ad) ranking information, comprising:
an Ad information collector for collecting Ad property information included in a plurality of advertisements;
a feedback information collector for collecting feedback information that is determined as a function of Ad impressions;
a table generator for generating an Ad information collection table as a function of the Ad property information and the feedback information;
a ranking calculator for generating Ad ranking information for the plurality of advertisements using the generated Ad information collection table; and
a processor for, upon receiving an Ad request from an Ad exposure device, requesting the plurality of advertisements from a plurality of Ad networks, receiving the requested plurality of advertisements from the plurality of Ad networks, receiving the feedback information from the Ad exposure device, and transmitting the generated Ad ranking information to the Ad exposure device along with the received plurality of advertisements.

2. The apparatus of claim 1, wherein the Ad property information includes a name of an Ad network providing advertisements, an Ad name, a category name, a Cost Per Millenium (CPM), and a Cost Per Click (CPC).

3. The apparatus of claim 1, wherein the feedback information includes a keyword, an Ad network name, a time, a revenue type, an impression count, a click count, revenue by impressions and revenue by clicks, for the plurality of advertisements.

4. The apparatus of claim 1, wherein the Ad information collection table includes an Ad name, an Ad network name, a request count, a response count, an average response time, an impression count, an average CPM, a click count and an average CPC, for each keyword or category.

5. The apparatus of claim 1, wherein the ranking calculator calculates estimated Ad revenues and credit ratings for the plurality of advertisements using the Ad information collection table, and generates the Ad ranking information as a function of the calculated estimated Ad revenues and credit ratings.

6. The apparatus of claim 5, wherein the estimated Ad revenue is a sum of an estimated impression revenue and an estimated click revenue.

7. The apparatus of claim 5, wherein the credit rating is a ratio of an average response time to a total Ad revenue up to now for each advertisement.

8. The apparatus of claim 5, wherein the ranking calculator generates Ad ranking information that is determined by assigning a highest ranking to an advertisement having the estimated highest Ad revenue and highest credit rating, and assigning a lowest ranking to an advertisement having the estimated lowest Ad revenue and lowest credit rating.

9. A method for providing advertising (Ad) ranking information in an Ad ranking information providing apparatus, comprising:
requesting a plurality of advertisements from a plurality of Ad networks, upon receiving an Ad request from an Ad exposure device;
receiving the plurality of advertisements from the plurality of Ad networks and collecting Ad property information included in the plurality of advertisements;
receiving feedback information that is determined as a function of Ad impressions, from the Ad exposure device, and collecting the feedback information;
generating an Ad information collection table as a function of the Ad property information and the feedback information;
generating Ad ranking information for the plurality of advertisements using the generated Ad informant collection table; and
transmitting the generated Ad ranking information to the Ad exposure device together with the plurality of advertisements.

10. The method of claim 9, wherein the Ad property information includes a name of an Ad network providing advertisements, an Ad name, a category name, a Cost Per Millenium (CPM), and a Cost Per Click (CPC).

11. The method of claim 9, wherein the feedback information includes a keyword, an Ad network name, a time, a revenue type, an impression count, a click count, revenue by impressions and revenue by clicks, for the plurality of advertisements.

12. The method of claim 9, wherein the Ad information collection table includes an Ad name, an Ad network name, a request count, a response count, an average response time, an impression count, an average CPM, a click count and an average CPC, for each keyword or category.

13. The method of claim 9, wherein generating Ad ranking information comprises:
calculating estimated Ad revenues and credit ratings for the plurality of advertisements using the Ad information collection table; and
generating the Ad ranking information as a function of the calculated estimated Ad revenues and credit ratings.

14. The method of claim 13, wherein the estimated Ad revenue is a sum of an estimated impression revenue and an estimated click revenue.

15. The method of claim 13, wherein the credit rating is a ratio of an average response time to a total Ad revenue up to now for each advertisement.

16. The method of claim 13, wherein generating Ad ranking information comprises:
assigning a highest ranking to an advertisement having the estimated highest Ad revenue and highest credit rating; and
assigning a lowest ranking to an advertisement having the estimated lowest Ad revenue and lowest credit rating.
